(19) United States
(12) Patent Application Publication
(10) Pub. No.: US 2010/0106268 A1
(43) Pub. Date: Apr. 29, 2010

(54) PACKET-BASED AUDIO CONVERSION AND DISTRIBUTION DEVICE

(75) Inventors: Jamie Christopher Howarter, Overland Park, KS (US); Douglas Bruce Ceballos, Olathe, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/260,874

(22) Filed: Oct. 29, 2008

(51) Int. Cl. G06F 17/00

(52) U.S. Cl. 700/94

(57) ABSTRACT

An embodiment of an apparatus for distributing a digital audio signal includes a digital audio to packet data converter configured to receive a digital audio signal and convert the digital audio signal to a packetized audio data stream. The embodiment of the apparatus further includes a wireless packet data transmitter configured to transmit the packetized audio data stream over a wireless connection, and a wired packet data transmitter configured to transmit the packetized audio data stream over a wired network connection. The embodiment of the apparatus further includes a powerline packet data transmitter configured to transmit the packetized audio data stream over a powerline network connection.

### BACKGROUND

The popularity of audio players, such as digital music players, has greatly increased in recent years. Oftentimes, a user of an audio player may wish to listen to music or other audio provided by the audio player in a different location than that in which the audio player is located.

### BRIEF SUMMARY

An embodiment of an apparatus for distributing a digital audio signal includes a digital audio to packet data converter configured to receive a digital audio signal and convert the digital audio signal to a packetized audio data stream. The embodiment of the apparatus further includes a wireless packet data transmitter configured to transmit the packetized audio data stream over a wireless connection, and a wired packet data transmitter configured to transmit the packetized audio data stream over a wired network connection. The embodiment of the apparatus further includes a powerline packet data transmitter configured to transmit the packetized audio data stream over a powerline network connection.

An embodiment of an apparatus for receiving a distributed digital audio signal includes a wireless packet data receiver configured to receive a packetized audio data stream over a wireless connection, and a wired packet data receiver configured to receive the packetized audio data stream over a wired network connection. The embodiment of the apparatus further includes a powerline packet data receiver configured to receive the packetized audio data stream over a powerline network connection. The embodiment of the apparatus further includes a packet data to digital audio converter configured to receive the packetized audio data stream from at least one of the wireless packet data receiver, the wired packet data receiver, and the powerline packet data receiver. In the embodiment, the packet data to digital audio converter further configured to convert the packetized audio data stream to a digital audio signal.

### BRIEF DESCRIPTION OF THE DRAWINGS

Illustrative embodiments of the present invention are described in detail below with reference to the attached drawing figures, which are incorporated by reference herein and wherein:

FIG. 1 is an embodiment of an audio-to-packet data distribution device;

FIG. 2A is an embodiment of a wireless distributed audio receiver;

FIG. 2B is an embodiment of a wired distributed audio receiver;

FIG. 2C is an embodiment of a powerline distributed audio receiver;

FIG. 2D is an embodiment of a distributed audio receiver; and

FIG. 3 is an embodiment of a system for distributing and receiving a packetized audio data stream.

### DETAILED DESCRIPTION

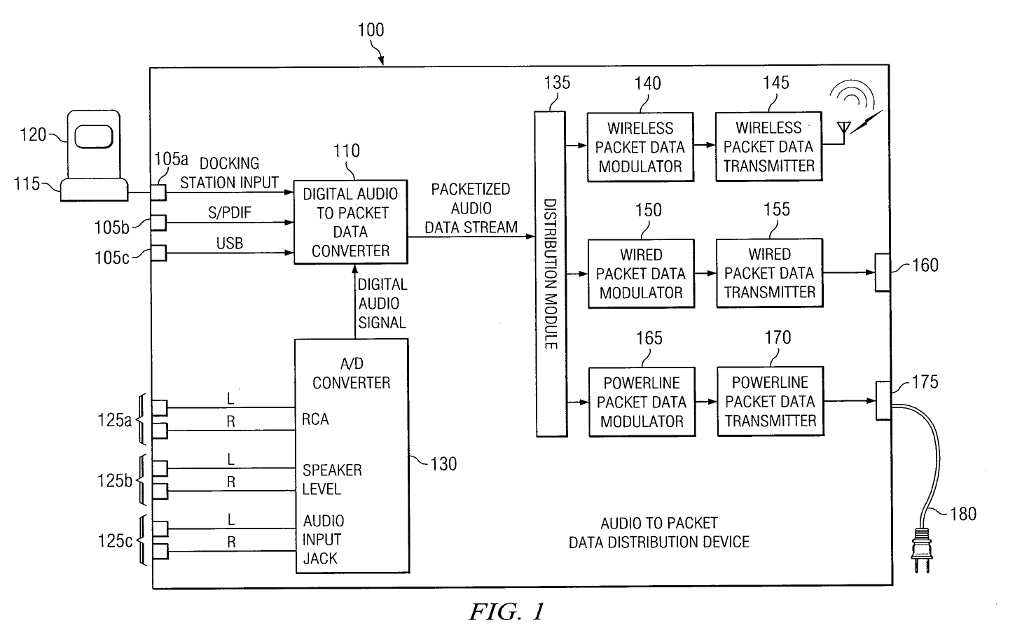

FIG. 1 is an embodiment of an audio-to-packet data distribution device 100. The audio-to-packet data distribution device 100 includes an analog to digital (A/D) converter 130. A digital audio-to-packet data converter 110, a distribution module 135, a wireless packet data modulator 140, and a wireless packet data transmitter 145. The audio-to-packet data distribution device 100 further includes a wired packet data modulator 150, a wired packet data transmitter 155, a power line packet data modulator 165, and a power line packet data transmitter 170. In various embodiments, the digital audio-to-packet data converter 110, the distribution module 135, the wireless packet data modulator 140, the wireless packet data transmitter 145, the wired packet data modulator 150, the wired packet data transmitter 155, the power line packet data modulator 165, and the power line packet data transmitter 170 of the audio-to-packet data distribution device 100 are contained within a single enclosure.

The audio-to-packet distribution device 100 further includes digital audio input connectors 105a-105c, including a docketing station input connector 105a, a Sony/Phillips digital interconnect format (S/PDIF) input connector 105b, and a universal serial bus (JSB) input connector 105c. Each of the digital audio input connectors 105a-105c are configured to receive a digital audio signal from an audio source and provide the audio signal to the digital audio-to-packet data converter 110. In an example embodiment, the docketing station input connector 105a is configured to be coupled to a digital audio player docking station 115. The digital audio player docking station 115 is configured to dock with a digital audio player 120. In an example embodiment, the digital audio player 120 is an iPod. In some embodiments, the S/PDIF input connector 105b is configured to receive a digital audio signal from an audio source via a coaxial digital cable. In another embodiment, the S/PDIF input connector 105b is configured to receive a digital audio signal from an audio source via an optical digital cable. In at least one embodiment, the USB input connector 105c is configured to be coupled to an audio source via a USB cable connection. In a particular embodiment, the USB input connector 105c may be coupled to a personal computer to receive a digital audio signal from the personal computer. In another embodiment, the USB input connector 105c may be coupled to a digital audio player to receive a digital audio signal from the digital audio player.

The audio-to-packet data distribution device 100 further includes analog audio input connectors 125a-125c. The analog audio input connectors 125a-125c include a left/right analog RCA input connector pair 125a, a left/right speaker-level analog input connector pair 125b, and a left/right audio input jack 125c. Each of the analog audio input connectors 125a-125c are configured to receive a stereo analog audio signal and provide the stereo audio analog signal to the A/D converter 130. The A/D converter 130 is configured to convert the stereo analog audio signal to a digital audio signal and provide the digital audio signal to the digital audio-to-packet data converter 110. The RCA audio input pair 125 is configured to receive an analog stereo audio signal from RCA output of an audio source. In a particular embodiment, the analog stereo audio signal is a line-level stereo audio signal. The speaker-level audio input pair 125b is configured to receive a speaker-level audio signal from speaker outputs of an audio source. The audio input jack 125c is configured to receive an audio plug to receive an audio input signal from an audio source. In at least one embodiment, the analog audio signal received by the audio input jack 125c is a line-level audio signal. In a particular embodiment, the audio input jack 125c is a 3.5 mm stereo input jack. In various embodiments, the audio source may include one or more of a stereo, a radio, an iPod, an mp3 player, a satellite receiver, a digital audio player, or any other audio source.

Upon receiving the digital audio signal, the digital audio-to-packet data converter 110 converts the digital audio signal to a packetized audio data stream and provides the packetized audio data stream to the distribution module 135. In at least one embodiment, the packetized audio data stream includes distributed Ethernet packets. The distribution module 135 is configured to selectively distribute the packetized audio data stream to one or more of the wireless packet data modulator 140, the wired packet data modulator 150, and the powerline packet data line modulator 165. In a particular embodiment, the distribution module 135 is configured to allow a user to select to which of the wireless packet data modulator 140, the wired packet data modulator 150, and the powerline packet data modulator 165 that the packetized audio data stream is to be distributed. Upon receiving the packetized audio data stream, the wireless packet data modulator 140 modulates and/or formats the packetized audio data stream for transmission over a wireless connection and provides the modulated packetized audio data stream to the wireless packet data transmitter 145. The wireless packet data transmitter 145 then transmits the modulated packetized audio data stream over a wireless connection. In at least one embodiment, the wireless connection is a WiFi connection. Upon receiving the packetized audio data stream, the wired packet data modulator 150 modulates and/or formats the packetized audio data stream for transmission over a wired network connection and provides the modulated packetized audio data stream to the wired packet data transmitter 155. The wired packet data transmitter 155 transmits the packetized audio data stream to a wired network connector 160. In a particular embodiment, the wired network connector 160 is an RJ45 connector. In at least one embodiment, the wired network connector 160 is configured to be coupled to a wired network transmits the packetized audio data stream to the wired network. In at least one embodiment, the packetized audio data stream is transmitted over a wired network using an Ethernet frame format.

Upon receiving a packetized audio stream, the powerline packet data modulator 165 modulates and/or formats the packetized audio data stream for transmission over a powerline network. The powerline packet data modulator 165 then provides the modulator packetized audio data stream to the powerline packet data transmitter 170 which transmits the modulated powerline packet data to a powerline network connector 175. The powerline network connector 175 is configured to couple to a powerline network interface cord 180. The powerline network interface cord 180 is configured to couple the powerline network connector 175 to a powerline network and transmit the packetized audio data stream to the powerline network. In at least one embodiment, the powerline packet data transmitter 170 is configured to transmit the modulated packetized audio stream using a HomePlug powerline communications standard. In various embodiments, the powerline network includes an AC power network. In some embodiments, the powerline network interface cord 180 may be further configured to provide AC power to the audio-to-packet data distribution device 100 to power the various components of the audio-to-packet data distribution device 100. In some embodiments, the AC power signal obtained via the power network interface cord 180 may be converted to a DC power signal prior to being supplied to the components of the audio-to-packet data distribution device 100. In various embodiments, the audio-to-packet data distribution device 100 is configured to receive either a digital or analog audio signal from an audio source, convert the audio signal to a packetized audio data stream, and distribute the packetized audio data stream over one or more of a wireless connection, a wired network connection, or a powerline network connection to be received by one or more receivers configured to receive a packet audio data stream over one or more of the wired network connections, the wired network connection, and the powerline network connection and reproduce the audio signal using one or more loudspeakers.

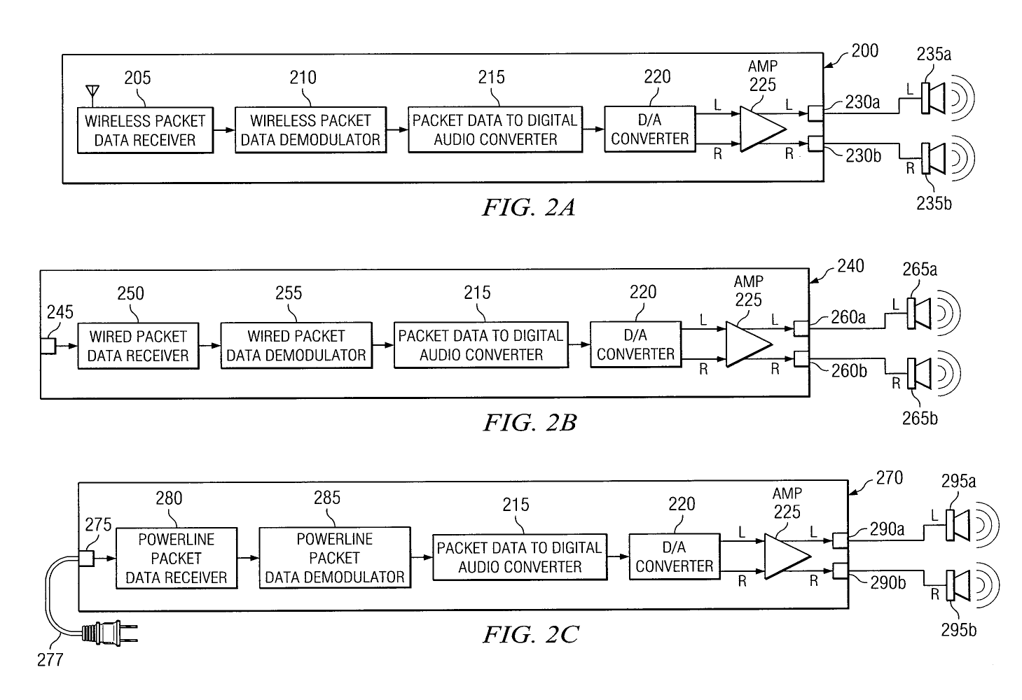

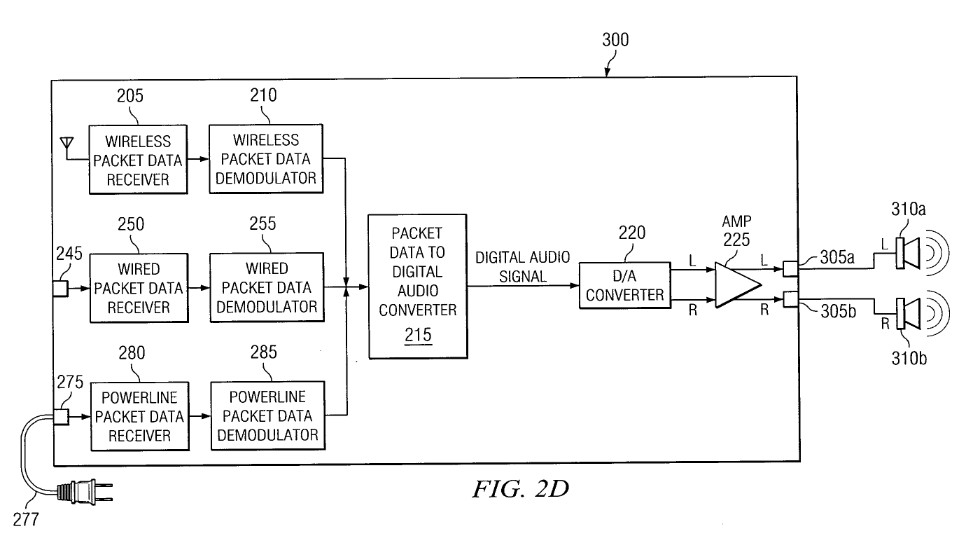

FIG. 2A is an embodiment of a wireless distributed audio receiver 200. The wireless distributed audio receiver 200 includes a wireless packet data receiver 205, a wireless packet data demodulator 210, a packet data to digital audio converter 215, a digital-to-analog (D/A) converter 220, and audio amplifier 225. In various embodiments, the wireless packet data receiver 205, the wireless packet data demodulator 210, the packet data to digital audio converter 215, the digital-to-analog (D/A) converter 220, and the audio amplifier 225 are contained within a single enclosure.

The wireless packet data receiver 205 is configured to receive a wirelessly transmitted packetized audio data stream from the audio-to-packet data distribution device 100 and provide the packetized audio data stream to the wireless packet data demodulator 210. The wireless packet data demodulator 210 demodulates the packetized audio data stream and provides the packetized audio data stream to the packet data to digital audio converter 215. The packet data to digital audio converter 215 converts the packetized audio data stream to a digital audio signal and provides the digital audio signal to the D/A converter 220. The D/A 220 converts the digital audio screen to a left and right analog audio signal, and provides the left and right analog audio signal to audio amplifier 225. The audio amplifier 225 amplifies the left and right analog audio signal to output a speaker-level left and right analog output signal to a left speaker-level output connector 230a and a right speaker-level output connector 230b, respectively. The left speaker-level output connector 230a is configured to be connected to a left audio loudspeaker 235a, and the right speaker-level output connection 230b is configured to be connected to a right audio loudspeaker 235b. In the embodiment illustrated in FIG. 2A, the left audio loudspeaker 235a and the right audio loudspeaker 235b are external speakers that are connected to the wireless packet data receiver 205. In still other embodiments, the left audio loudspeaker 235a and the right audio loudspeaker 235b may be integrated within an enclosure of the wireless packet data receiver 205.

In accordance with various embodiments, the wireless distributed audio receiver 200 is configured to receive the packetized audio data stream from the audio-to-packet data distribution device 100 and reproduce the audio signal provided to the audio-to-packet data distribution device 100 via the left audio loudspeaker 235a and right audio loudspeaker 235b.

FIG. 2B is an embodiment of a wired distributed audio receiver 240. The wired distributed audio receiver 240 includes a wired network input connector 245, a wired packet data demodulator 255, a packet data to digital audio converter 215, a D/A converter 220, and an audio amplifier 225. In various embodiments, the wired network input connector 245, the wired packet data demodulator 255, the packet data to digital audio converter 215, the D/A converter 220, and the audio amplifier 225 are contained within a single enclosure.

The wired network input connector 245 is configured to receive the packetized audio data stream from the audio-to-packet data distribution device 100 via a wired network connection. The wired network input connector 245 provides the packetized audio data stream to the wired packet data receiver 250, and the wired packet data 250 provides the packetized audio data stream to be wired to the packet data demodulator 255. The wired packet data demodulator 255 demodulates the packetized audio data stream and provides the demodulated packetized audio data stream to the packet data to digital audio converter 215. The packet data to digital audio converter 215 converts the packetized audio data stream to a digital audio signal and provides the digital audio signal to the D/A converter 220. The D/A 220 converts the digital audio screen to a left and right analog audio signal, and provides the left and right analog audio signal to audio amplifier 225. The audio amplifier 225 amplifies the left and right analog audio signal to output a speaker-level left and right analog output signal to a left speaker-level output connector 260a and a right speaker-level output connector 260b, respectively. The left speaker-level output connector 260a is configured to be connected to a left audio loudspeaker 265a, and the right speaker-level output connection 260b is configured to be connected to a right audio loudspeaker 265b. In accordance with various embodiments, the wireless distributed audio receiver 200 is configured to receive the packetized audio data stream from the audio-to-packet data distribution device 100 and reproduce the audio signal provided to the audio-to-packet data distribution device 100 via the left audio loudspeaker 265a and the right audio loudspeaker 265b. In the embodiment illustrated in FIG. 2B, the left audio loudspeaker 265a and the right audio loudspeaker 265b are external speakers that are connected to the wired distributed audio receiver 240. In still other embodiments, the left audio loudspeaker 235a and the right audio loudspeaker 235b may be integrated within an enclosure of the wired distributed audio receiver 240.

In various embodiments, the wired distributed audio receiver 240 is configured to receive the packetized audio data stream from the audio-to-packet data distribution device 100 via a wired network connection and reproduce the packetized audio data stream as an analog stereo audio signal via the left audio loudspeaker 265a and the right audio loudspeaker 265b.

FIG. 2C is an embodiment of a powerline distributed audio receiver 270. The powerline distributed audio receiver 270 includes a powerline network input connector 275, a powerline packet data receiver 280, a powerline packet data demodulator 285, a packet data-to-digital audio converter 215, a D/A converter 220, and an audio amplifier 225. In various embodiments, the powerline network input connector 275, the powerline packet data receiver 280, the powerline packet data demodulator 285, the packet data-to-digital audio converter 215, the D/A converter 220, and the audio amplifier 225 are contained within a single enclosure.

The powerline network input connector 275 is configured to receive a packetized audio data stream from the audio-to-packet data distribution device 100 via a powerline network. The powerline distributed audio receiver 270 may be further provided with a powerline network interface cord 277 configured to couple the powerline network input connector 275 to a powerline network. In various embodiments, the powerline network interface cord 277 may be further configured to provide power to various components of the powerline distributed audio receiver 270. The powerline network input connector 275 is configured to provide the packetized audio data stream to the powerline packet data receiver 280. The powerline packet data receiver 280 provides the packetized audio data stream to the powerline data demodulator 285. The powerline packet data demodulator 285 demodulates the packetized audio data stream and provides the demodulated packetized audio data stream to the packet data-to-digital audio converter 215. The packet data to digital audio converter 215 converts the packetized audio data stream to a digital audio signal and provides the digital audio signal to the D/A converter 220. The D/A converter 220 converts the digital audio screen to a left and right analog audio signal, and provides the left and right analog audio signal to audio amplifier 225. The audio amplifier 225 amplifies the left and right analog audio signal to output a speaker-level left and right analog output signal to a left speaker-level output connector 290a and a right speaker-level output connector 290b, respectively. The left speaker-level output connector 290a is configured to be connected to a left audio loudspeaker 295a, and the right speaker-level output connection 290b is configured to be connected to a right audio loudspeaker 295b. In the embodiment illustrated in FIG. 2C, the left audio loudspeaker 295a and the right audio loudspeaker 295b are external speakers that are connected to the powerline distributed audio receiver 270. In still other embodiments, the left audio loudspeaker 295a and the right audio loudspeaker 295b may be integrated within an enclosure of the powerline distributed audio receiver 270.

In accordance with various embodiments, the wireless distributed audio receiver 200 is configured to receive the packetized audio data stream from the audio-to-packet data distribution device 100 and reproduce the audio signal provided to the audio-to-packet data distribution device 100 via the left audio loudspeaker 295a and right audio loudspeaker 295b. In various embodiments, the wired distributed audio receiver 240 is configured to receive the packetized audio data stream from the audio-to-packet data distribution device 100 via a wired network connection and reproduce the packetized audio data stream as an analog stereo audio signal via the left audio loudspeaker 295a and the right audio loudspeaker 295b.

FIG. 2D is an embodiment of a distributed audio receiver 300. The distributed audio receiver 300 is operable to receive a packetized audio data stream from the audio-to-packet data distribution device 100 via one or more of a wireless connection, a wired network connection, and a powerline network connection and reproduce a speaker-level audio output signal. The distributed audio receiver 300 includes the wireless packet data receiver 205, the wireless packet data demodulator 210, the wired network input connector 245, the wired packet receiver 250, the wired packet data demodulator 255, the powerline network input connector 275, the powerline packet data receiver 280, and the powerline packet demodulator 285. The distributed audio receiver 300 further includes a packet data-to-digital audio converter 215, the D/A converter 220, the audio amplifier 225, a left speaker-level output connector 305a, and a right speaker-level output connector 305b. In various embodiments, the wireless packet data receiver 205, the wireless packet data demodulator 210, the wired network input connector 245, the wired packet receiver 250, the wired packet data demodulator 255, the powerline network input connector 275, the powerline packet data receiver 280, the powerline packet demodulator 285, the packet data-to-digital audio converter 215, the D/A converter 220, and the audio amplifier 225 are contained within a single enclosure.

The wireless packet data receiver 205 is configured to receive a wirelessly transmitted packetized audio data stream from the audio-to-packet data distribution device 100 and provide it to the wireless packet data demodulator 210. The wireless packet data demodulator 210 provides a demodulated packetized audio data stream to the packet data to digital audio converter 215. The wired packet data receiver 250 is configured to receive a packetized audio screen from a wired network and provide the packetized audio data stream to the wired packet data demodulator 255. The wired packet data demodulator 255 is configured to demodulate the packetized audio data stream and provide the demodulating packetized audio data stream to the packet data-to-digital audio converter. The powerline packet data receiver 280 is configured to receive an audio data stream from a powerline network and provide the packetized audio data stream to the powerline packet data demodulator 285. The powerline packet data demodulator 285 provides a demodulated packetized audio data stream to the packet data-to-digital audio converter 215. In some embodiments, a powerline network interface cord 277 may be coupled to the powerline network input connector 275 to connect the powerline packet data receiver 280 to a powerline network. In some embodiments, the powerline network interface cord 277 may be further configured to provide power to the various components of the distributed audio receiver 300.

By providing wireless, wired network, and powerline receiver and demodulator components, the distributed audio receiver 300 may be configured to receive a packetized audio data stream using either a wireless connection, a wired connection, or a powerline network connection. In some embodiments, a user of the distributed audio receiver 300 may select which of the wireless, wired network, or powerline network connections is to be used to receive a packetized audio data stream from the packet audio-to-packet data distribution device 100. In still other embodiments, the distributed audio receiver 300 may automatically select which of the wireless, wired network, or powerline network connections is to be used to receive the packetized audio data stream. For example, the distributed audio receiver 300 may detect if a packetized audio data stream is being received by either of the wireless packet data receiver 205, the wired packet receiver 250, or the powerline packet data receiver 280, and automatically select the connection that contains packetized audio data.

The packet data-to-digital audio converter 215 receives the demodulated packetized audio data stream and produces a digital audio signal. The digital audio signal is received by the D/A converter 220, and the D/A converter 220 produces a left and right analog audio output. The left and right analog audio output is received by the audio amplifier 225, and the audio amplifier 225 amplifies the left and right analog audio signals to produce a speaker-level left and right audio signal to the left speaker-level output connector 305a and the right speaker-level output connector 305b, respectively. A left audio loudspeaker 310a and a right audio loudspeaker 310b may be coupled to the left speaker-level output connector 305a and the right speaker-level output connector 305b, respectively. The left audio loudspeaker 310a and the right audio loudspeaker 310b may then reproduce the stereo audio signal input into the audio-to-packet data distribution device 100. In the embodiment illustrated in FIG. 2D, the left audio loudspeaker 310a and the right audio loudspeaker 310b are external speakers that are connected to the distributed audio receiver 300. In still other embodiments, the left audio loudspeaker 310a and the right audio loudspeaker 310b may be integrated within an enclosure of the distributed audio receiver 300.

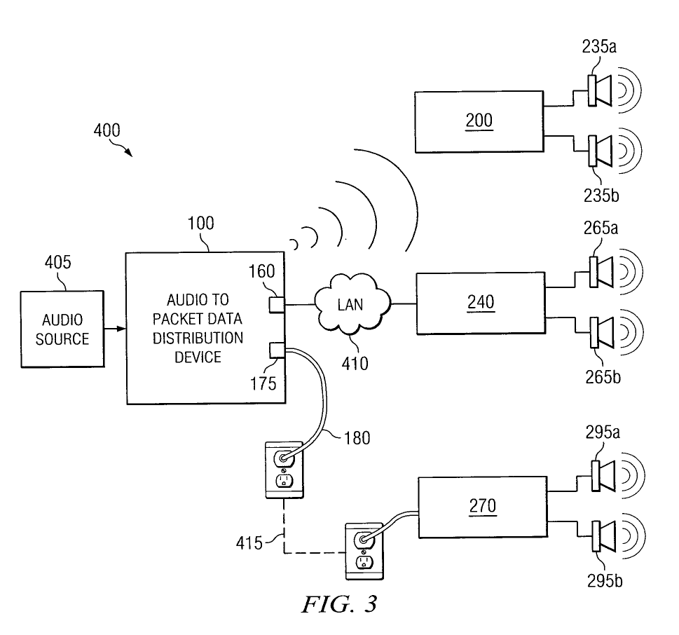

FIG. 3 is an embodiment of a system 400 for distributing and receiving a packetized audio data stream. The system 400 includes an audio source 405, an audio-to-packet data distribution device 100, a wireless distributed audio receiver 200, a wired distributed audio receiver 240, and a powerline distributed audio receiver 270.

The audio source 405 may include any source of analog and/or digital audio. For example, the audio source 405 may include a digital music player, an iPod, a radio, a stereo, a CD player, satellite radio, a personal computer (PC), or any other audio source. In a particular embodiment, the audio source 405 may include one or more stored audio files, for example mp3 files. The audio-to-packet data distribution device 100 has a wireless connection to the wireless distributed audio receiver 200, a wired network connection to the wired distributed audio receiver 240 via a local area network (LAN) 410, and a powerline connection to the powerline distributed audio receiver 270 via a powerline network 415. In an example operation of the system 400 of FIG. 3, the audio source 405 provides an audio signal, such as a stereo audio signal, to the audio-to-packet data distribution device 100. The audio-to-packet data distribution device 100 converts the audio signal to a packetized audio data stream, and distributes the packetized audio data stream to one or more of the wireless distributed audio receiver 200, the wired distributed audio receiver 240, and the powerline distributed audio receiver 270. As previously discussed herein, one or more of the wireless distributed audio receiver 200, the wired distributed audio receiver 240, and the powerline distributed audio receiver 270 may then reproduce the audio signal from the audio source 405 using the connected loudspeakers 235a, 235b, 265a, 265b, 295a, and 295b, connected thereto. The system 400 of FIG. 3 allows a user or users to distribute an audio signal from the audio source 405 to a number of remote locations at a distance from the audio source 405. For example, a user or users of the system 400 may distribute audio obtained from the audio source 405 to one or more rooms throughout a home and listen to the audio at each of the remote locations.

Although the illustrated embodiments are described as using stereo analog and digital audio signals, it should be understood that monaural audio signals or multi-channel audio signals, such as 5.1 or 7.1 channel signals, may be used in some embodiments.

The illustrative embodiments can take the form of an entirely hardware embodiment, an entirely software embodiment, or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The computer-usable or computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Further, a computer storage medium may contain or store a computer-readable program code, such that when the computer-readable program code is executed on a computer, the execution of this computer-readable program code causes the computer to transmit another computer-readable program code over a communication link. This communication link may use a medium that is, for example, without limitation, physical, or wireless.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. An apparatus for distributing a digital audio signal comprising:
a digital audio to packet data converter configured to receive a digital audio signal and convert the digital audio signal to a packetized audio data stream;
a wireless packet data transmitter configured to transmit the packetized audio data stream over a wireless connection;
a wired packet data transmitter configured to transmit the packetized audio data stream over a wired network connection; and
a powerline packet data transmitter configured to transmit the packetized audio data stream over a powerline network connection.

2. The apparatus of claim 1, further comprising:
a distribution module configured to receive the packetized audio data stream and selectively distribute the packetized audio data stream to at least one of the wireless packet data transmitter, the wired packet data transmitter, and the powerline packet data transmitter.

3. The apparatus of claim 2, wherein the distribution module is further configured to allow a user to select to which of the wireless packet data modulator, the wired packet data modulator and the powerline packet data modulator that the packetized audio data stream is to be distributed.

4. The apparatus of claim 1, further comprising:
an analog to digital converter configured to receive an analog audio signal and convert the analog audio signal into the digital audio signal, the analog to digital converter further configured to provide the digital audio signal to the digital audio to packet data converter.

5. The apparatus of claim 4, further comprising:
at least one analog audio input connector in communication with the analog to digital converter, the at least one digital audio input connector configured to receive the analog audio signal and provide the analog audio signal to the analog to digital converter.

6. The apparatus of claim 5, wherein the at least one analog audio input connector includes at least one of a left/right analog RCA input connector pair, a left/right speaker-level analog input connector pair, and a left/right audio input jack.

7. The apparatus of claim 1, further comprising:
at least one digital audio input connector in communication with the digital audio to packet data converter, the at least one digital audio input connector configured to receive the digital audio signal and provide the digital audio signal to the digital audio to packet data converter.

8. The apparatus of claim 7, wherein the at least one digital audio input connector includes at least one of a docketing station input connector, an S/PDIF input connector, and a USB input connector.

9. The apparatus of claim 1, further comprising:
a wired network connector configured to receive the packetized audio data stream from the wired packet data transmitter, the wired network connector further configured to be coupled to a wired network and transmit the packet audio data stream to the wired network.

10. The apparatus of claim 1, further comprising:
a powerline network connector configured to receive the packetized audio data stream from the powerline packet data transmitter, the powerline network connector further configured to be coupled to a powerline network and transmit the packet audio data stream to the powerline network.

11. The apparatus of claim 1, wherein the digital audio to packet data converter, the wireless packet data transmitter, the wired packet data transmitter, and the powerline packet data transmitter are contained within a single enclosure.

12. The apparatus of claim 1, wherein the packetized audio data stream includes Ethernet packets.

13. An apparatus for receiving a distributed digital audio signal comprising:
a wireless packet data receiver configured to receive a packetized audio data stream over a wireless connection;
a wired packet data receiver configured to receive the packetized audio data stream over a wired network connection;
a powerline packet data receiver configured to receive the packetized audio data stream over a powerline network connection; and
a packet data to digital audio converter configured to receive the packetized audio data stream from at least one of the wireless packet data receiver, the wired packet data receiver, and the powerline packet data receiver, the packet data to digital audio converter further configured to convert the packetized audio data stream to a digital audio signal.

14. The apparatus of claim 13 further comprising:
a digital to analog converter configured to receive the digital audio signal from the packet data to digital audio converter and convert the digital audio signal to at least one analog audio signal.

15. The apparatus of claim 13 further comprising:
an audio amplifier configured to receive the at least analog audio signal and convert the at least one analog signal to at least one speaker-level analog output signal.

16. The apparatus of claim 15 further comprising:
at least one speaker-level output connector configured to receive the at least one speaker-level analog output signal.

17. The apparatus of claim 16, wherein the at least one speaker-level output connector is further configured to be coupled to at least one audio loudspeaker.

18. The apparatus of claim 13 further comprising:
a wired network input connector configured to receive the packetized audio data stream from a wired network and provide the packetized audio data stream to the wired packet data receiver.

19. The apparatus of claim 13 further comprising:
a powerline network input connector configured to receive the packetized audio data stream from a powerline network and provide the packetized audio data stream to the powerline packet data receiver.

20. The apparatus of claim 13, wherein the wireless packet data receiver, the wired packet data receiver, the powerline packet data receiver, and the packet data to digital audio to converter are contained within a single enclosure.
